(19) United States
(12) Patent Application Publication
(10) Pub. No.: US 2026/0226996 A1
(43) Pub. Date: Aug. 6, 2026

(54) HYDRAULIC CORE TUBE FOR A SOLENOID VALVE ARRANGEMENT

(71) Applicant: Danfoss A/S, Nordborg (DK)

(72) Inventors: Nitin Matkar, Pune (IN); David Green, Havant (GB); Nitin Jagannath Patel, Pune (IN)

(21) Appl. No.: 19/145,071

(22) PCT Filed: Jan. 4, 2024
(86) PCT No.: PCT/EP2024/050132

§ 371 Date: Jul. 1, 2025

(30) Foreign Application Priority Data
Jan. 6, 2023 (IN) 202311001294
Mar. 9, 2023 (DE) 102023105834.7

(51) Int. Cl. F16K 31/06; H01F 7/08; H01F 7/127; H01F 41/02

(52) U.S. Cl. CPC F16K 31/0679; H01F 7/127; H01F 41/0206; H01F 2007/085

(57) ABSTRACT

Disclosed is a solenoid actuator for hydraulic valves having a single piece core tube and method for manufacturing a single piece core tube for being used in a solenoid valve arrangement showing a basically cylindrical body, including of magnetic metal material, and defining a rotational axis. The single piece core tube is divided axially into a pole section, a transition section and a tube section including of a blind bore in the core tube. The medial end of the blind bore is formed by the transition section. In the tube section an armature is accommodated moveably in direction of the rotational axis. The outer diameter of the cylindrical body in the transition section is set back radially to form a magnetic flux deviation groove such that the metallic wall thickness in the transition section is smaller than in the tube section. According to the disclosure the magnetic flux deviation groove is filled by poured or molded plastic material up to the outer diameter of the cylindrical body. The blind bore in tube section is connected with a pin guiding bore to the pole section, wherein the two bores have different diameters. A plunger is arranged in the pin guiding bore in the pole section and is moveable via the armature. Further, a coil is surrounding the single piece core tube in the pole section, the transition section and the tube section.

### CROSS-REFERENCE TO RELATED APPLICATIONS

This application is a National Stage application of International Patent Application No. PCT/EP 2024/050132, filed on Jan. 4, 2024, which claims priority to Indian Patent Application No. 202311001294, filed on Jan. 6, 2023, and German Patent Application No. 102023105834.7, filed on Mar. 9, 2023, each of which is hereby incorporated by reference in its entirety.

### TECHNICAL FIELD

The invention relates to a core tube for a solenoid valve arrangement. The invention also relates to a solenoid valve arrangement comprising such a core tube. In particular the invention relates to core tubes for solenoid valve arrangements used in the field of hydraulic or pneumatic, e.g., in fluidics as a drive for actuating hydraulic or pneumatic valves.

### BACKGROUND

Solenoid valve arrangements in fluidics are usually of modular construction and have a basically cylindrical core tube made of magnetic metal material accommodating in a tube section a movable armature operable with electromagnetic forces generated by a coil surrounding the core tube. The armature is moveable in longitudinal cylinder direction together with a plunger transmitting the armature movement to the outside of the solenoid valve arrangement.

Such a core tube comprises a pole section and a tube section with a longitudinal blind hole. Between the pole section and the tube section a transition section is located at the medial end of the tube section, i.e., the transition section forms the medial part of the tube section. In a solenoid valve arrangement, the core tube is surrounded by an electric coil which can be charged by an electric current for generating an electromagnetic field to build-up a magnetic flux along the core tube in order to move a cylindrical armature from an initial position in the core tube to an actuated position. For this the length of the armature is shorter than the depth of the blind hole. In the initial position a gap between the armature and the bottom of the blind hole, i.e., at the beginning of the pole section, is present. Usually, the gap is part of the transition section. At the distal end of the tube section the core tube is closed, frequently fluid-tight, by an end plug.

In order to provoke a discontinuity in the magnetic flux along the core tube, i.e., that the magnetic field lines do not pass along the tubular walls to and from the pole section only, since to and from the pole segment through the centre of the transition section, i.e., at least partially through the tubular section, a non-magnetic groove, e.g. an air gap in form of a groove is introduced in the outer surface of the core tube in the transition section.

This is shown, e.g., with U.S. 2015/0179322 A1 showing a solenoid drive device with an increased diameter portion in the magnetic flux deviation groove that is formed so that its thickness in the radial direction is increased in a continuous or stepwise manner in order to achieve constant actuation forces in dependency of the position of a plunger attractable by magnetic forces when a current is connected to the coil of the solenoid drive device.

As the transition section forms the medial end of the tube section, the transition section due to the outside groove comprises a lower tube wall thickness such that a discontinuity in the magnetic flux is achieved. The lower the thickness of the tube wall in the transition section the better/greater the deviation of the magnetic flux from the pole section of the core tube to the transition section. To compensate the weakening effect of the groove in the transition section and to maintain in parallel the deviation of the magnetic flux to the transition section a non-magnetic metal material is usually introduced in the transition section.

In the state of the art the transition section of a single piece core tube shows a groove in the form of an encircling groove, a magnetic separating non-magnetic metal material is inserted into the groove, typically by building-up welding or braze filling in order to insert a mechanical resistant non-magnetic material which keeps the deviation of the magnetic flux through the gap in the transition section. For this, e.g., tin, copper or a tin and solder filling material is filled into the groove. Other state of the art uses a ring element of a non-magnetic metal material with a bigger diameter than the core tube and deforms the ring material plastically by milling or rolling into the groove of the transition section. Thus, when the coil is energized magnetic flux keeps flowing over the pole section and the transition section whereby the armature is attracted by the magnetic field towards the pole section and moving a plunger/actuator pin outwards or inwards in axial direction of the core tube.

In parallel to magnetic deviation the non-magnetic metal material filled in the groove have to fulfil a mechanically stabilizing function of the one piece core tube in the transition section, as the wall thickness of the core tube in this section is reduced with respect to the rest of the core tube, especially in the tube section. Hence non-magnetic metal material is the choice in the art to fill up the groove, preferably up to the outer diameter of the core tube. Processes Filling-up the gap by welding, brazing, plastically deformation with or without using heat, are used in the art, which lead to the disadvantage that apart from being costly and, due to their high energy consumption, which is harmful to the environment, they do not superimpose very precisely non-magnetic metal material in the transition section to ensure a smooth transition from the pole section to the tube section on the outer diameter and vice versa. Means rework is usually necessary to come to a constant outer diameter along the whole cylindrical surface of the core tube. Such a constant diameter is required to maximise the magnetic force which can be generated by the coil surrounding the core tube of a solenoid valve arrangement. For this-as known by a person with skills in the relevant art-the coil should fit as closely to the core tube as possible as any (air) gap between the coil inner cylindrical surface and the outer surface of core tube will reduce the magnetic flux through the pole section and the armature.

Such stabilizing solutions according to the state of the art are shown, e.g., in U.S. 2022/0336131 A1 or WO 2015/114894 A1.

Another weak point of the state of the art solution lays in the fact that a process building-up metal material by welding or brazing is always accompanied by a difficult handling leading to dirt and an instable process complicated to automate. Therefore, frequently a high portion of manual interference is needed to achieve an acceptable result, which makes the core tube expensive. Furthermore, especially when high temperatures or high mechanical forces are needed to fill-up the groove in the transition section of a single piece core tube, the wall thickness in this area can often not be selected to the required minimum thickness for achieving highest possible magnetic forces on the armature as breakage of the core tube has to be avoided during re-filling the groove in the transition section and assembly of the armature, fixation of the end cap (usually screwed or crimped) and/or assembly of the solenoid valve arrangement.

### SUMMARY

Therefore it is the objective of the present invention to provide a simple, secure, clean and cost effective possibility to fill-up the magnetic flux deviation groove in the transition section of a single piece core tube, which is environment friendly and reduces rework effort to a minimum for achieving a smooth finish with a constant diameter at the outer surface of the single piece core tube in order to minimise any gap between the single core tube according to the invention and a coil surrounding the core tube in a solenoid valve arrangement. Furthermore, the core tube of the invention should be capable to replace already existing core tubes in solenoid valve arrangements of the state of the art.

The objective of the present invention is solved by a single piece core tube according to claim 1, wherein preferred embodiments are provided by the subclaims depending on claim 1. A solenoid valve arrangement is provided using such a single piece core tube. The objective of the invention is further achieved by the claimed method wherein preferred embodiments of the invention are disclosed by the corresponding subclaims.

A core tube according to the invention, which can be used in solenoid valve arrangements shows a basically cylindrical form, is made of magnetic metal material, and defines a rotational axis of the core tube. The core tube is axially divided in a pole section, a transition section and a tube section consisting of a blind hole in the core tube. The medial end of the blind hole is formed by the transition section. An armature is accommodated moveably in direction of the rotational axis in the tube section. In the transition section the outer diameter of the core tube is set back radially to form a circular groove such that the wall thickness in the transition section is smaller than in the tube section. According to the invention the groove is filled by poured or moulded plastic material up to the outer diameter of the tube section.

According to the invention the tube section of the single piece core tube shows basically the form of a blind hole along the rotational axis. The inner or medial end of the blind hole, i.e., the bottom of the blind bore is common to the pole section which extends towards the other distal end of the core tube. In the pole section another axial bore connecting the blind hole in the transition section and the tube section with the distal end of the pole section can be arranged in the core tube. In this axial bore a plunger or actuator pin can be received for transmitting a movement of the armature in the transition section to the exterior of the core tube. However, such a pin or plunger can also be fixed to the other end of the armature and protruding to the exterior passing through an end cap closing the blind bore at the distal end of the tubular section. In this embodiment the pole section must not comprise a central bore and magnetic flux is enhanced in this area.

In the initial position of the armature a gap between the bottom of the blind hole and the armature is provided. The axial length of this gap typically lies in the transition section of the single piece core tube. Means that the transition section is the section where the pole section passes to the tube section and where the magnetic deviation groove is located as well as a gap for the armature movement is provided.

According to the invention the armature is also made of a magnetic material in order to be attractable by the magnetic flux passing through the pole section, the transition section and the tube section of the single piece core tube. Thereby the outer diameter of the armature fits in the diameter of the blind bore in tube section such that the armature can move smoothly in direction of the rotational axis. Due to the groove in the transition section of the single piece core tube deviating/guiding the magnetic flux generated by a coil surrounding the single piece core tube from the pole section via the transition section and tube section, the armature can move towards the transition section when the coil is energized. Depending on the polarity of the electrical connection of the coil the magnetic flux passes from the pole section via the armature to the tube section or vice versa. In both cases the armature is attracted by the magnetic flux in direction towards the pole section such that the initial position of the armature in the tube section is selected to be distant from the bottom of the blind bore in the tube section, i.e., the armature forms a gap with the pole section. The armature is held in this initial position by means of a spring force, wherein the spring must not be part of the single piece core tube according to the invention. Radially parallel to the gap between the armature and the pole section the magnetic deviation groove is formed in the outer wall of the single piece core tube reducing in this area the wall thickness of the tubular part of the single piece core tube.

As the magnetic flux deviating groove is filled or over moulded according to the invention with poured or moulded plastic material the magnetic flux can be deviated, as plastic material is not magnetic. In the sense of the invention there are a multitude of possibilities to form the magnetic flux deviation groove, e.g., it is brought-in during casting or after casting the single piece core tube by means of turning. One possibility to fill the magnetic flux deviation groove with plastic material according to the invention is to place the single piece core tube in a mould having a hollow tubular cavity corresponding to the external diameter of the core tube extending over the transition section and over mould an enclosed single piece core tube with plastic material to fill the magnetic flux deviation groove. This small ring-like cavity can be filled, e.g., by pouring or injection moulding with melted plastic material in fluid conditions and let the plastic material cure afterwards.

According to one embodiment of the invention the used plastic material for filling-up the magnetic flux deviation groove can be a reinforced plastic material, e.g., reinforced by carbon or glass fibres. For the selection of the plastic material with which the magnetic flux deviation groove can be filled all kind of plastic material is suitable as long as it does not contain magnetic characteristics. Thermoplastic plastic materials can be used as well as duroplastic materials. A person with skills in the relevant art will find for this a huge variety of plastic materials which fulfil the mechanical requirements and to provide sufficient stability to the transition section of a single piece core tube having a magnetic flux deviation groove in the transition section.

In a simple embodiment of the core tube according to the invention the magnetic flux deviation groove can show a basically rectangular, conical, or rounded cross section as these basic geometric forms can be realized easily by means of turning the magnetic flux deviation groove to a standard cylindrical metal material. By designing the cross section of the magnetic flux deviation groove other conditions can be considered as best form for deviating the magnetic flux or best cross section for achieving high mechanical stability. By doing these studies the inventors of the present invention have found that in a preferred embodiment the cross section of the magnetic flux deviation groove should have a relief-like cross section. For fulfilling highest possible mechanical strength, the magnetic flux deviation groove is filled with plastic material according to the invention. Thereby relief-like means that the bottom surface of the magnetic flux deviation groove is not flat, since shows at least one hump, rib, or protrusion in the radial direction, which enhances the mechanical stability not only in the axial direction since also the mechanical stability with regard to bent forces. At the same time the plastic material adjacent to the at least one hump, rib or protrusion allow the magnetic flux generated by a coil surrounding the single piece core tube, to pass from the pole section via the transition section to the tube section. Thereby a magnetic force exerted on the armature is not lowered as the influence of the hump, rib, or protrusion on the deviated magnetic flux is minimum and the armature can move towards the transition section when the coil is energized.

Naturally the bottom surface can show more than one hump, e.g., two or three humps parallel in axial direction, wherein the radial height of the humps is lower than the depth of the magnetic flux deviation groove. The number of parallel humps will be limited by the axial extension of the magnetic flux deviation groove as the axial extension is limited by the magnetic flux which can be generated/deviated via the magnetic flux deviation groove. When the magnetic flux deviation groove is too large in axial direction, no or too low magnetic force can be generated at all over the single core tube. Hence a compromise has to be found between mechanical stability and generatable magnetic forces.

A further improvement of mechanical stability can be achieved by hardening the cylindrical body after the magnetic flux deviation groove is realized, e.g., by nitro carburizing which forms a compound and/or diffusion layer connecting/bonding the metal material of the cylindrical body of the core tube. Such a nitro carburizing enhances, as other hardening processes known to a person skilled in the art, the surface hardness of the single piece core tube, provides a high wear resistance, an excellent fatigue strength, and does not distort the material structure.

In another preferred embodiment of the invention the magnetic flux deviation groove shows side walls which are inclined with respect the orthogonal direction to the axial direction of the single piece core tube. Such an inclination of the side walls enhances the deviation effect of the grove for the magnetic flux as sharp corners are avoided, which hinder the deviation of the magnetic flow. As every inclination deviating from the orthogonal direction reduces the axial length of the magnetic flux deviation groove and the possibility of arranging humps or ribs or channels at the bottom surface of the magnetic flux deviation groove, the angles of the two side walls can be selected to be different. To find the best inclination of the two side walls, simulations methods can be applied. A first analysis done by the inventors provided the fact that the side wall surface closer to the pole section should show a greater inclination-a flatter angle with respect to the axial direction-then the side wall surface of the magnetic flux deviation groove facing to the tube section. Hereby a first indication leads to angles in the range of 20° to 60° could probably provide an optimum. More particular 30° to 40°, even more particular 32 to 36° could provide an optimum. Although this theory has to be proven by simulation and testing, as this result was achieved by arranging only one hump on the bottom surface of the magnetic flux deviation groove. Analogous the side surfaces of the hump/rib also can be inclined respect to the perpendicular direction of the axial direction to find an optimum compromise between best magnetic flux deviation and mechanical stability of the transition section of the single piece core tube according to the invention having a magnetic flux deviation groove filled with plastic material.

As a result of the cross section geometry of the magnetic flux deviation groove an optimum for achieving the highest possible magnetic force on the armature can be found by obtaining at the same time a sufficient mechanical stability. Therefore, it is preferred to do studies and simulations for each individual geometric condition, in particular for different outer and inner diameter ratios of the tube section with regard to the pole section and the moving path length of the armature required for the application of a solenoid valve arrangement according to the invention. In summary the magnetic flux deviation groove according to the invention can be realized deeper in the tube section compared to the state of the art as forces for pouring or injection moulding of plastic material into the groove are less than used in the state of the art processes. Further, a greater stability is achieved as the homogeneity of the plastic material filled into groove is enhanced do the fact the plastic material can be brought-in in the molten or in a curable liquid state such that complete filling without air inclusions is achieved, and therewith a higher mechanical strength. According to the invention a metallic wall thicknesses in the transition section of the core tube can be achieved with a range of between 40% and down to 10% or even zero with respect to the metallic wall thickness in the tube section.

In one embodiment of the invention the core tube can be manufactured in a way that in the transition section the metal material is completely interrupted, i.e., that in axial direction no continuity of metal material is provided, i.e., in a short area the wall thickness of the metal material in the transition section can be zero. This can be achieved by introducing the blind hole in the cylindrical body of the single piece core tube posterior to over moulding and curing the plastic material in the magnetic flux deviation groove. Therewith the diameter of the blind hole in the transition section can be chosen such big that the metal material in short regions in the transition section inside the magnetic flux deviation groove is reduced to zero. In this embodiment the plastic material bonds the pole section with the tube section. For the realization of this embodiment an accurate study of the magnetic flux deviation groove geometry has to done to achieve the required mechanical stability of the single piece core tube according to the invention. Here it would be imaginable for manufacturing purposes that an over-mould form or die is used for filling the magnetic flux deviation groove with plastic material which is used also as support for drilling the blind hole and/or the plunger guidance bore, as well as for assembling the armature in the core tube and closing the transition section by an end cap, e.g., by screwing or crimping. After complete assembly of the single piece core tube a coil or winding can be attached around the cylindrical body of the core tube to provide more mechanical stability to the solenoid valve arrangement. A person skilled in the art will understand that this way of manufacturing is not limited to tube sections having a tube inner diameter greater than the smallest magnetic flux deviation groove diameter since it is applicable also to all other embodiments.

In another manufacturing embodiment of the core tube according to the invention the blind hole in the tube section can be brought-in first into a bar, e.g., a standard bar or cylindrical rod. Afterwards a mandril can be used to support the tube section for introduction of the magnetic flux deviation groove on the exterior surface by turning, e.g. In a next step the magnetic flux deviation groove is over-moulded by plastic material and assembly of the armature, the plunger and the end cap complete the single piece core tube assembly according to the invention.

The single piece core tube is part of a solenoid valve arrangement according to invention which can be used, e.g., in industrial environments and/or in stationary systems. Thus the solenoid valve arrangement may be installed to production equipment, chemical and industries, wind turbines, trains, construction work vehicles, forestry and agriculture equipment, elevators, and a lot more hydraulic applications, a person skilled in the relevant art is aware of.

The solenoid valve arrangement according to the invention is capable to operate hydraulic valves for controlling hydraulic fluids under pressures of more than 1 bar up to 500 bar, and/or for controlling hydraulic fluid flows up to 100 Liters per minute. Such hydraulic valves, as control, directional control valves, pilot valves, flow valves or the like, may route and/or control hydraulic fluid under high pressure in a hydraulic circuit. For this a precise and often speedy actuation of a solenoid actuator is required, even in harsh environments. Thereby the solenoid actuator often does not have to act against the hydraulic fluid pressure since to move a valve spool or piston in order to open and/or close hydraulic lines or restrict the hydraulic fluid flow through such hydraulic lines. In some cases big flow rates pass through flow valves or in cases as for pilot valves nearly no flow but high pressure is routed to a hydraulic component.

To reduce actuation forces inside the solenoid actuator according to invention the shell surface of the armature or the blind bore in the single piece core tube is treated or covered with a friction reducing material, like a coating or a friction reducing spacer, e.g. a Teflon® spacer, can be arranged between the shell surfaces of the armature and the blind bore. As such friction reduction are known by a person skilled in the relevant art all common measures are covered by the invention.

In a preferred embodiment a Teflon® spacer disposed between the armature and the single piece core tube which adds a synergistic effects to the single piece core tube, as the Teflon spacer reduces friction and simultaneously increases the mechanical stability of the single piece core tube. In combination with the single piece core tube this allows to achieve the necessary balance between electrical performance and mechanical durability which is necessary for the valve. The use of a friction reducing tube (spacer) between armature and core tube improves the performance curve and achieves a smooth force versus stroke curve, because such a friction reduction lowers the sticking effect of the armature on the shell surface of the blind bore. This also reduces hysteresis and improves the accuracy and positioning while reducing actuation forces, Hence lower magnetic forces are necessary to move the armature, which means also that higher actuation forces can be achieved as friction losses are reduced.

Further, a friction reducing measure also increases the lifetime and/or the service time of a solenoid actuator according to the invention, which can be further enhanced by a heat treatment to single piece core tube also improving the strength to sustain high pressure requirements and for fulfilling high fatigue life requirements, as often 10 million or more cycles are required, especially in safety applications.

### BRIEF DESCRIPTION OF THE DRAWINGS

In the following the invention is detailed for explanation reasons only by the help of specific embodiments shown in the Figures attached. It is to be understood that the embodiments shown in the Figures do not limit the scope of the invention and only depict possible embodiments and their manufacturing methods. The Figures show:

FIG. 1 schematically an embodiment of a single piece core tube according to the invention;

FIG. 2 schematically an enlarged detail of the embodiment shown in FIG. 1;

FIG. 3 schematically an embodiment of a solenoid valve arrangement of the invention in an initial position;

FIG. 4 schematically an embodiment of a solenoid valve arrangement of the invention in an actuated position;

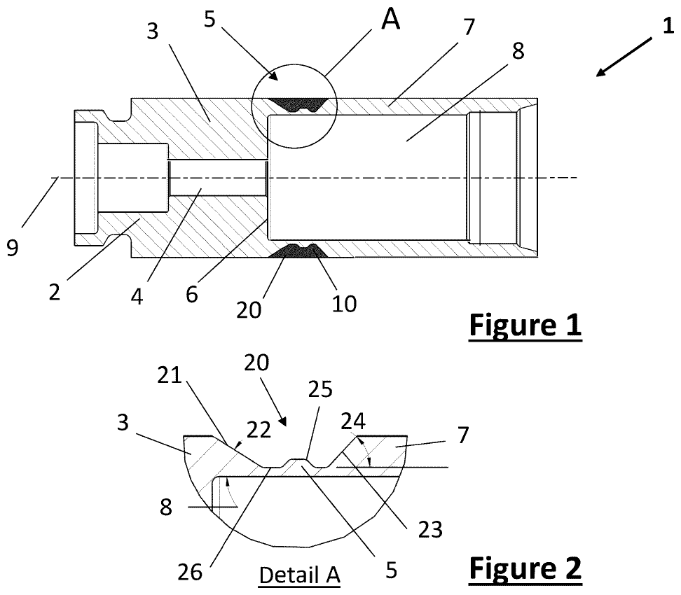

In the different embodiments shown in the FIGS. 1 to 4 parts, elements or sections having the same or equivalent function are indicated with the same reference number for a better legibility and easier understanding.

### DETAILED DESCRIPTION

FIG. 1 shows schematically an embodiment of a single piece core tube 1 according to the invention having a basically cylindrical body 2 defining a rotational axis 9. In the cylindrical body 2 a blind bore 8 is brought-in at one distal end of the cylindrical body 2. The area where the blind bore 8 is located forms a tube section 7 of the single piece core tube 1 according to the invention. The tube section 7 is closed at its medial end by a bottom surface 6 being part of a pole section 3. Through the pole section 3 extends a pin guiding hole 4 for receiving a pin or plunger 37 to transmit the movement of an armature 35 moveably arranged in direction of the rotational axis 9 in the blind bore 8.

A transition section 5 adjacent to the bottom surface 6 is formed on the side of the blind bore 8 in which the outer diameter of the cylindrical body 2 is set back and a magnetic flux deviation groove 20 is formed in the outer surface of the cylindrical body 2. According to the invention the magnetic flux deviation groove 20 is filled with plastic material 10 which can be brough-in the magnetic flux deviation groove 20 by pouring or injection moulding, e.g., or by over moulding. The plastic material may be a homogenous thermoplastic or duroplastic plastic material or a reinforced plastic material, e.g., reinforced by carbon or glass fibres. As the magnetic flux deviation groove 20 fulfils the function to deviate the magnetic flow as it constitutes an air gap for the magnetic flux, the plastic material 10 filled in the magnetic flux deviation groove 20 provides for the required mechanical stability of the single piece core tube 1 according to the invention.

FIG. 2 depicts the magnetic flux deviation groove 20 of the embodiment of FIG. 1 in an enlarged view, wherein for explanation reasons only, the magnetic flux deviation groove 20 is shown without plastic material 10 to be filled-in to complete the single piece core tube 1 according to the invention. From this it can be seen in more detail that in this preferred embodiment of the invention the magnetic flux deviation groove 20 is formed relief-like. This means that the bottom surface 26 of the magnetic flux deviation groove 20 is not flat or even since it shows a kind of relief. This relief is optimized to deviate the magnetic flow in its way through the transition section 5 smoothly and effectively from the pole section 3 towards the tubular section 7. For this the side walls 21 and 23 are inclined with respect to a perpendicular direction to the rotational axis 9 of the single piece core tube 1 according to the invention. Here, in this embodiment of the invention, the side wall 21 adjacent to the pole section 3 shows a flatter angle 22 with respect to the rotation axis 9 than the side wall 23 adjacent to the tube section 7. In simulations done by the inventors a range for the angle 22 from 20° to 60 ° of the side wall 21 adjacent to the pole section 3 was found to be reasonable in view of finding a compromise with the length of the bottom surface 26 of magnetic flux deviation groove 20. For the other side wall 23 a range for angle 24 was found preferably from 30° to about 70°.

The steeper the angles 22 and 24 the longer the horizontal area, i.e., the bottom surface 26 of the magnetic flux deviation groove 20 can be and the more stiffening enhancing material can be formed therein. In Detail A shown in FIG. 2 a hump 25 is formed enhancing the mechanical stability of the transition section 5 especially in the longitudinal direction and against bent forces. A person skilled in the art will detect a multitude of other possibilities for enhancing mechanical stiffness of the magnetic flux deviation groove 20 which according to the invention is filled by plastic material 10. So, the magnetic flux deviation groove 20 can show undercuts in direction of the rotational axis 9, e.g., in form of channels or the like. All these modifications from the general form depicted with Detail A in FIG. 2 are covered by the idea of the invention.

As can be derived also from the Detail A in FIG. 2—at least by a person skilled in the relevant art—the metallic wall thickness of the cylindrical body 2 of the single piece core tube 1 in the transition section 5 is very much lower than the wall thickness in the tube section 7. The lower the metallic wall thickness in the transition section 5 the better the magnetic flux can be deviated from the pole section 3 to the tube section 7, and a higher the magnetic force that can be generated in the blind bore 8 for attracting an armature 35 towards the pole section 3. As mentioned already above the metallic wall thickness in the transition section 5 can be even zero, in case the blind hole 8 is manufactured in the tube section 7 subsequent to forming and filling the magnetic flux deviation groove 20 in the cylindrical body 2 with plastic material 10. However as can be seen also in Detail A of FIG. 2 in view of FIG. 1 the overall wall thickness of the single piece core tube 1 in the transition section 5, means the plastic wall thickness together with the metallic wall thickness is equal to the metallic wall thickness in the tube section 7, i.e., in the transition section 5 the wall thicknesses of the metallic material of the cylindrical body 2 and the thickness of the plastic material are added, or the complete thickness is built only by plastic material 10 only.

In order to enhance mechanical strength of the magnetic flux deviation groove 20 filled with plastic material 10 a hardening process can be applied to the cylindrical body 2 of the single piece core tube 1. Here, preferably before the over-moulding the cylindrical body 2 with plastic material the cylindrical body 2 is hardened, e.g., by means of nitro carburizing at temperatures between 490° C. to 580° C. After the hardening step the plastic material can be filled into the magnetic flux deviation groove 20.

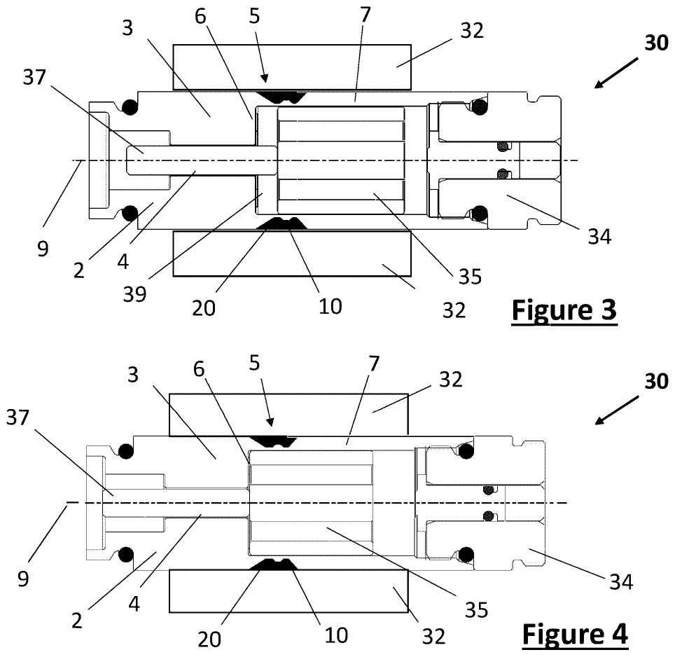

In FIGS. 3 and 4 an embodiment of a solenoid valve assembly 30 is shown, wherein an armature 35 is received in the blind bore 8 and arranged in the blind bore 8 such that a gap 39 is formed between the armature 35 and the bottom surface 6 of the blind bore 8. Blind bore 8 is closed by an end cap 34 which can be screwed or crimped, e.g., to the distal end of the tube section 7. Usually end cap 34 is fixed fluid tight to the open end of the blind bore 8 in the tube section 7. On the other side of the armature 35 a plunger or pin 37 is attached to the armature 35 and can move with the armature 35, thereby guided by a pin guiding bore 4 in the cylindrical body 2.

FIG. 3 shows the solenoid valve assembly 30 in an initial or default state when a coil 32 surrounding the cylindrical body 2 of the single piece core tube 1 is not energized, meaning no magnetic force is generated, which would attract the armature 35 towards the bottom surface 6 of the blind hole 8, i.e., towards the pole section 3. Frequently the armature 35 is hold/biased in this position by a spring force, e.g., attacking on a plunger/pin 37 at the outside of solenoid valve assembly 30 (not shown). Hence, in the position of armature 35 in FIG. 3 a gap 39 between the bottom surface 6 and the armature 35 is present, whose width is usually less than the width of the transition section 5 such that the magnetic attracting force generated by the deviated magnetic flux on the armature 35 is sufficient to move the armature 35 together with the plunger 37 towards the pole section 3, i.e., the bottom surface 6 of the blind bore 8.

For generating this magnetic attracting force on the armature 35 coil 32 can be energized with a current. Thereby the magnetic force on the armature 35 depends on a multitude of factors as known by a person skilled in the relevant art, like the height of the current, the distance of the armature 35 from the pole section 3, i.e., the width of the gap 39 between the armature 35 and the bottom surface 6 of the blind bore 8, the materials of the single piece core tube 1 and the armature 35. But the magnitude of the magnetic attraction force also depends on the deviation form or curve of the magnetic flux, and the distance of the magnetic flux from the outer surface of the cylindrical body 2 of the single piece core tube 1, hence the wall thickness in tube section should not be too big. For smoothening the curve of deviation of the magnetic flux, the magnetic deviation groove 20 according to the invention is designed with inclined side walls 21 and 23 such that the magnetic flux generated by the energized coil 32 surrounding the single piece core tube 1 does hit these side walls perpendicular or sharp edges are formed. Also, the depth of magnetic flux deviation groove is optimised for achieving a high magnetic flux through the blind hole diameter in the transition section 5.

FIG. 4 shows the solenoid valve assembly 30 according to the invention in an actuated state in with the gap 39 is closed and the plunger/pin 37 is guided in a pin guiding hole 4 pushed by the armature 35 towards the other distal end of the single piece core tube 1 opposite to the blind hole 8. By means of the movement of the plunger 37 the movement and magnetic force on the armature 35 can be transmitted to the exterior of the solenoid valve assembly 30, e.g., for actuating a control or flow valve or any other valve used in fluidics. Thereby, as known by a person skilled in the relevant art the magnetic force can be generated proportional on the armature 35 by means of applying a proportional current at the coil 32. The higher the current the higher the magnetic force on the armature 35. By doing this and using an adequate spring biasing the armature 35 into the initial position also the magnitude of the movement of the armature 35 can be controlled proportionally due to a spring creating a force increasing with the magnitude of depression, e.g.

Basically, there are two methods for manufacturing a single piece core tube 1 according to the invention, the first one comprising:

Providing a cylindrical body 2, for example by cutting the cylindrical body 2 of magnetic metal material and realizing first in the next step the magnetic flux deviation groove 20 as a reset in the outer diameter of the cylindrical body 2 in the transition section 5. Filling in the next step the magnetic flux deviation groove 20 with plastic material 10 by pouring, moulding, injection moulding, or over-moulding. In the next step the blind bore 8 is realized by parallel supporting the cylindrical body 2 at the outer surface of the cylindrical body 2. After finishing the external and internal surfaces of the single piece core tube 1 the final assembly of the solenoid valve assembly 30 can start, e.g., by mounting the armature 35 into the blind bore 8 and closing the blind bore 8 with an end cap 34, e.g., by screwing or crimping. Finally, the coil 32 can placed around the cylindrical body 2 covering the pole section 3, the transition section 5, and at least partially the tube section 7.

The other method for manufacturing a single piece core tube 1 according to the invention comprises the steps of:

Providing a cylindrical body, for example by cutting a cylindrical body of magnetic metal material and realizing first in the next step the blind bore 8 in the cylindrical body 2. Then realizing in the transition section 5 the magnetic flux deviation groove 20 by supporting in parallel the cylindrical body 2 by means of, e.g., a mandril in the blind bore 8. After this step the magnetic flux deviation groove 20 is filled with plastic material 10 by pouring, moulding, injection mould, or over-moulding. After finishing the external and internal surfaces of the core tube final assembly of the single piece core tube can be done equal to the method descript above.

From the above disclosure and accompanying Figures and claims, it will be appreciated that the single piece core tube 1 according to the invention and the solenoid valve assembly 30 according to the invention offer many possibilities and advantages over the prior art. It will be appreciated further by a person skilled in the relevant art that further modifications and changes known in the art could be made to the single piece core tube 1 according to the invention and the solenoid valve assembly 30 according to the invention without parting from the spirit of this invention. Therefore, all these modifications and changes are within the scope of the claims are covered by them. It should be further understood that the examples and embodiments described above are for illustrative purposes only and that various modifications, changes, or combinations of embodiments in the light thereof, which will be suggested to a person skilled in the relevant art, are included in the spirit and purview of this application.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A solenoid actuator for hydraulic valves having a single piece core tube for being used in a solenoid valve arrangement showing a basically cylindrical body consisting of magnetic metal material and defining a rotational axis, wherein the single piece core tube is divided axially into a pole section, a transition section and a tube section consisting of a blind bore in the cylindrical body, whose medial end is formed by the transition section, in the blind bore an armature is accommodated moveably in direction of the rotational axis, wherein the outer diameter of the cylindrical body in the transition section is set back radially to form a magnetic flux deviation groove such that the metallic wall thickness in the transition section is smaller than in the tube section, wherein the magnetic flux deviation groove is filled by poured or molded plastic material up to the outer diameter of the cylindrical body, wherein the blind bore in tube section is connected with a pin guiding bore to the pole section, wherein the two bores have different diameters and a plunger is arranged in the pin guiding bore in the pole section and is moveable by means of the armature, wherein further a coil is surrounding the single piece core tube in the pole section, the transition section and the tube section wherein the bottom surface of the groove is not flat and shows at least one hump/rib extending basically perpendicular to the rotational axis, whose radial extension is smaller than the radial extension of the cylindrical body.

2. The solenoid actuator according to claim 1, wherein the plastic material is a reinforced plastic material, reinforced by glass or carbon fibers.

3. The solenoid actuator according to claim 1, wherein the groove shows a basically conical cross section.

4. The solenoid actuator according to claim 1, wherein the groove shows a relief-like cross section.

5. The solenoid actuator according to claim 1 wherein the two side walls of the groove show different angles with respect to the rotational axis.

6. The solenoid actuator according to claim 5, wherein the angle of the first side wall closer to the pole section shows, with respect to the rotational axis, a greater inclination than the angle of the other second side wall.

7. (canceled)

8. The solenoid actuator according to claim 1, wherein the metallic wall thickness of the core tube in the transition section is lower than 40% of the wall thickness in the tube section, preferably lower than 30% of the wall thickness in the tube section, even more preferably lower than 20% of the wall thickness in the tube section.

9. The solenoid actuator according to claim 1, wherein the cylindrical body is hardened, preferably by nitro carburizing.

10. The solenoid actuator according to claim 1, wherein the shell surface of the armature or the blind bore is treated or covered with a friction reducing material or a friction reducing spacer is arranged between the shell surfaces of the armature and the blind bore.

11. A solenoid valve arrangement comprising a solenoid actuator according to claim 1 further comprising a control or flow valve or any other hydraulic valve, like directional or pilot valves.

12. The solenoid valve arrangement according to claim 10, for use in an industrial environment and/or use in stationary systems.

13. The solenoid valve arrangement according to claim 10, capable to operate hydraulic valves for controlling hydraulic fluids under pressures of more than 1 bar up to 500 bar, and/or for controlling hydraulic fluid flows up to 100 Liters per minute.

14. A method for manufacturing a single piece core tube for being used in a solenoid valve arrangement showing a basically cylindrical body consisting of magnetic metal material and defining a rotational axis, wherein the single piece core tube is divided axially into a pole section, a transition section and a tube section consisting of a blind bore in the cylindrical body, whose medial end is formed by the transition section comprising at the outside a magnetic flux deviation groove filled by plastic material up to the outer diameter of the cylindrical body, comprising the step of:
Providing a bar of magnetic metal material;
Realizing the magnetic flux deviation groove in the transition section with at least the bottom surface of the groove one hump/rib extending basically perpendicular to the rotational axis, and whose radial extension is smaller than the radial extension of the cylindrical body;
Filling the magnetic flux deviation groove with plastic material by pouring, molding or molding-over;
Realizing the blind bore by supporting the cylindrical body at the outer surface;
Finishing external and internal surfaces of the single piece core tube.

15. A method for manufacturing a single piece core tube for being used in a solenoid valve arrangement showing a basically cylindrical body consisting of magnetic metal material and defining a rotational axis, wherein the single piece core tube is divided axially into a pole section, a transition section and a tube section consisting of a blind bore in the cylindrical body, whose medial end is formed by the transition section comprising at the outside a magnetic flux deviation groove filled by plastic material up to the outer diameter of the cylindrical body, comprising the step of:
Providing a bar of magnetic metal material;
Realizing the blind bore in the cylindrical body;
Realizing by supporting the cylindrical body by means of a mandril in the blind bore, the magnetic flux deviation groove in the transition section with at least one hump/rib at the bottom surface of the groove extending basically perpendicular to the rotational axis, and whose radial extension is smaller than the radial extension of the cylindrical body;
Filling the magnetic flux deviation groove with plastic material by pouring, molding or molding-over;
Finishing external and internal surfaces of the core tube.

16. The method according to claim 14, wherein the magnetic flux deviation groove is realized by turning, rolling and/or grinding.

17. The method according to claim 14 comprising the further step of assembling an armature to the blind bore in tube section and closing the distal end of the blind bore with an end cap by screwing or crimping.

18. The method according to claim 14 comprising the further step of encapsulating the single piece core tube with a coil at the pole section, the transition section, and the tube section.
